(19) United States
(12) Patent Application Publication
(10) Pub. No.: US 2025/0291161 A1
(43) Pub. Date: Sep. 18, 2025

(54) FIXED-FOCUS LENS AND PROJECTOR

(71) Applicant: SEIKO EPSON CORPORATION, Tokyo (JP)

(72) Inventor: Hitoshi HIRANO, Suwa-shi (JP)

(73) Assignee: SEIKO EPSON CORPORATION, Tokyo (JP)

(21) Appl. No.: 19/076,237

(22) Filed: Mar. 11, 2025

(30) Foreign Application Priority Data
Mar. 12, 2024 (JP) 2024-038041

(51) Int. Cl. G02B 13/16; G02B 9/64; G02B 13/00

(52) U.S. Cl. CPC G02B 13/16; G02B 9/64; G02B 13/0045

(57) ABSTRACT

A fixed-focus lens includes: a first lens group; an aperture stop; and a second lens group sequentially arranged from an enlargement side toward a reduction side, the first and second lens groups having positive refractive power. In the first group, a lens closest or second closest to the enlargement side is an aspherical lens. The fixed-focus lens satisfies conditional expressions below.

$$ω > 45 \qquad ( 1 )$$

$$0.15 < L 1 H / LL < 0.4 \qquad ( 2 )$$

$$2.5 < BF / F < 3.5 \qquad ( 3 )$$

The value ω represents the largest half viewing angle of the lens, the value L1H represents the height of the beam passing through the top of the maximum image height at the surface of the lens closest to the enlargement side, the value LL is the length of the lens, the value BF represents the back focal length in air, and the value F represents the focal length of the entire lens.

The present application is based on, and claims priority from JP Application Serial Number 2024-038041, filed Mar. 12, 2024, the disclosure of which is hereby incorporated by reference herein in its entirety.

### BACKGROUND

### 1. Technical Field

The present disclosure relates to a fixed-focus lens and a projector including the fixed-focus lens.

### 2. Related Art

There is a known projection lens including a first lens group having negative refractive power and a second lens group having positive refractive power, the lens groups sequentially arranged from the enlargement side, the reduction side of the projection lens being a substantially telecentric system (JP-A-2009-104048).

JP-A-2009-104048 is an example of the related art.

The projection lens described above is an optical system having a wide-angle field of view and providing relatively favorable image performance, but has a large lens length and a large lens diameter, and therefore has problems of poor installation adaptability, restrictions on the product design and exterior appearance, and other disadvantages.

### SUMMARY

A fixed-focus lens according to an aspect of the present disclosure including: a first lens group; an aperture stop; and a second lens group sequentially arranged from an enlargement side toward a reduction side, the first and second lens groups each having positive refractive power, wherein a lens closest to the enlargement side or a lens second closest to the enlargement side in the first lens group is an aspherical lens, the reduction side of the fixed-focus lens is a telecentric system, and the fixed-focus lens satisfies conditional expressions below.

$$ω > 45 \qquad ( 1 )$$

$$0.15 < L 1 H / LL < 0.4 \qquad ( 2 )$$

$$2.5 < BF / F < 3.5 \qquad ( 3 )$$

In the conditional expressions, the value ω represents a largest half viewing angle of the fixed-focus lens, the value L1H represents a height of a beam passing through a top of a maximum image height at a lens surface of the fixed-focus lens that is closest to the enlargement side, the value LL is a length of the fixed-focus lens, the value BF represents a back focal length in air, and the value F represents a focal length of the entire fixed-focus lens.

A projector according to another aspect of the present disclosure including: an image forming section including a light modulator configured to modulate light from a light source apparatus to form image light; and the fixed-focus lens described above, which projects the image light from the image forming section.

### BRIEF DESCRIPTION OF THE DRAWINGS

FIG. 1 illustrates a projector including a fixed-focus lens according to an embodiment.

FIG. 2 shows the configuration and a beam diagram of the fixed-focus lens according to the embodiment.

FIG. 3 shows the state in which the fixed-focus lens according to the embodiment projects light onto a screen.

FIG. 4 shows the configuration of a fixed-focus lens according to Example 1.

FIG. 5 shows the characteristics of the longitudinal aberrations produced by the fixed-focus lens according to Example 1.

FIG. 6 shows the configuration of a fixed-focus lens according to Example 2.

FIG. 7 shows the characteristics of the longitudinal aberrations produced by the fixed-focus lens according to Example 2.

FIG. 8 shows the configuration of a fixed-focus lens according to Example 3.

FIG. 9 shows the characteristics of the longitudinal aberrations produced by the fixed-focus lens according to Example 3.

FIG. 10 shows the configuration of a fixed-focus lens according to Example 4.

FIG. 11 shows the characteristics of the longitudinal aberrations produced by the fixed-focus lens according to Example 4.

### DESCRIPTION OF EMBODIMENTS

### Embodiment

A fixed-focus lens 40 according to an embodiment of the present disclosure and a projector 2 incorporating the fixed-focus lens 40 will be described below with reference to the drawings.

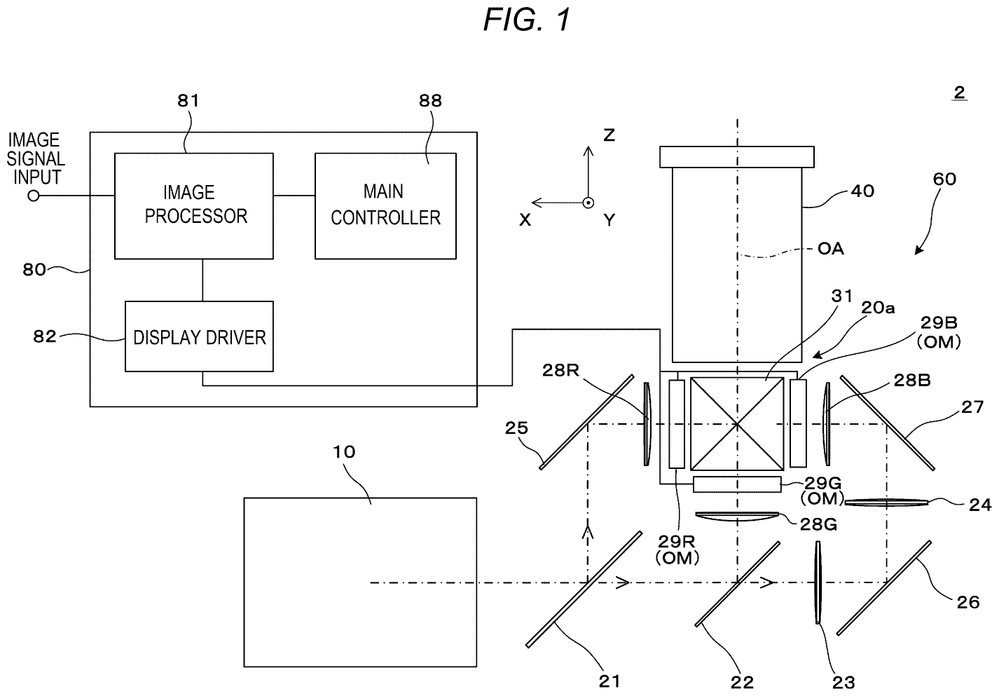

The projector 2, which incorporates the fixed-focus lens 40 according to the embodiment, includes an optical system section 60, which projects image light, and a circuit apparatus 80, which controls the operation of the optical system section 60, as shown in FIG. 1.

In the optical system section 60, a light source apparatus 10 outputs homogenized light containing R light, G light, and B light. The light source apparatus 10 includes a light source lamp that is, for example, an ultrahigh-pressure mercury lamp, a two-stage optical integration lens including multiple lens elements arranged in an array, a polarization converter that converts the light having passed through the two-stage optical integration lens into predetermined linearly polarized light, and a superimposing lens that superimposes illumination light output from the optical integration lens downstream from the polarization converter on display regions of liquid crystal panels 29R, 29G, and 29B.

A first dichroic mirror 21 reflects the R light incident from the light source apparatus 10 and transmits the G light and the B light. The R light reflected off the first dichroic mirror 21 enters the liquid crystal panel 29R, which is a light modulator OM, via a reflection mirror 25 and a field lens 28R. The liquid crystal panel 29R modulates the R light in accordance with an image signal to form an R image.

A second dichroic mirror 22 reflects the G light from the first dichroic mirror 21 and transmits the B light. The G light reflected off the second dichroic mirror 22 enters the liquid crystal panel 29G, which is another light modulator OM, via a field lens 28G. The liquid crystal panel 29G modulates the G light in accordance with an image signal to form a G image. The B light having passed through the second dichroic mirror 22 travels via relay lenses 23 and 24, reflection mirrors 26 and 27, and a field lens 28B, and enters the liquid crystal panel 29B, which is another light modulator OM. The liquid crystal panel 29B modulates the B light in accordance with an image signal to form a B image.

A cross dichroic prism 31 is a prism for light combination, and combines the light modulated by the liquid crystal panel 29R, the light modulated by the liquid crystal panel 29G, and the light modulated by the liquid crystal panel 29B with one another into image light, and causes the image light to travel to the fixed-focus lens 40.

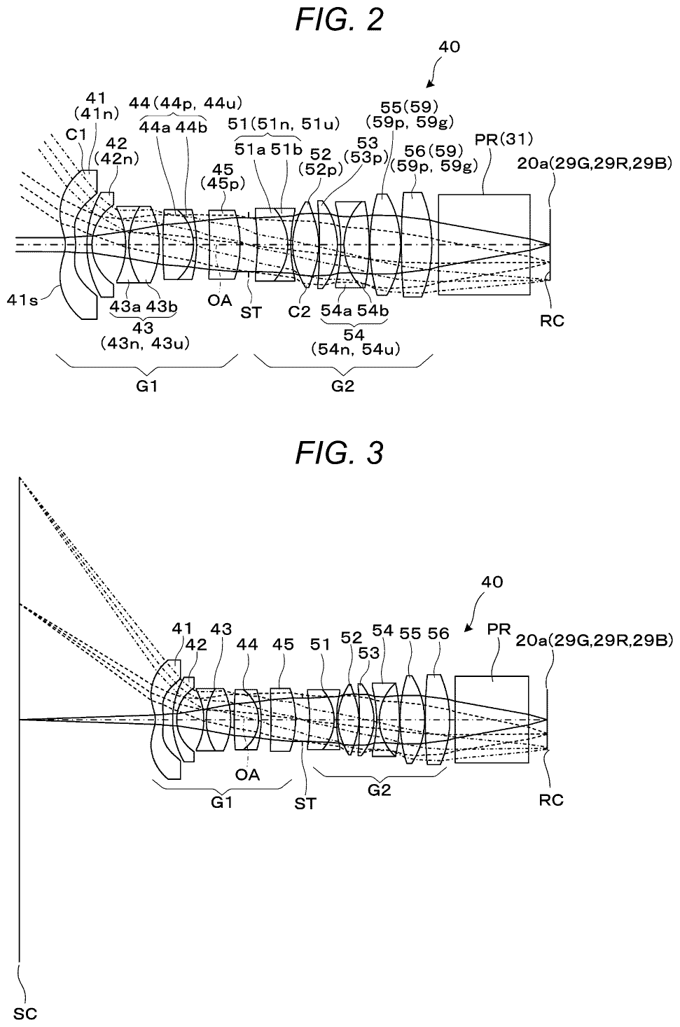

The fixed-focus lens 40 is a projection lens that enlarges the image light as a result of the modulation performed by the liquid crystal panels 29R, 29G, and 29B and the light combination performed by the cross dichroic prism 31, and projects the enlarged image light onto a screen SC that is not shown. The liquid crystal panels 29R, 29G, and 29B form an image forming section 20a, which forms projection image in a reduction-side conjugate plane RC (see FIG. 2 described later) of the fixed-focus lens 40.

The circuit apparatus 80 includes an image processor 81, to which an external image signal such as a video signal is input, a display driver 82, which drives the liquid crystal panels 29R, 29G, and 29B provided in the optical system section 60 based on an output from the image processor 81, and a main controller 88, which harmoniously controls the operations of the circuit sections 81 and 82 and the like.

The image processor 81 converts the input external image signal into image signals containing grayscales and other factors of the multiple colors. The image processor 81 can also perform various types of image processing, such as distortion correction and color correction, on the external image signal.

The display driver 82 can operate the liquid crystal panels 29R, 29G, and 29B based on the image signals output from the image processor 81, and can cause the liquid crystal panels 29R, 29G, and 29B to form images corresponding to the image signals or images corresponding to the image signals on which image processing has been performed.

The fixed-focus lens 40 according to the embodiment will be specifically described below with reference to FIGS. 2 and 3. FIG. 2 shows the configuration and a beam diagram of the fixed-focus lens 40 according to the embodiment. FIG. 3 shows the state in which the fixed-focus lens 40 according to the embodiment projects light onto the screen SC. Note that the fixed-focus lens 40 shown in FIG. 2 by way of example has the same configuration as the fixed-focus lens 40 according to Example 1, which will be described later.

The fixed-focus lens 40 according to the embodiment projects an image formed at a projection receiving surface of the liquid crystal panel 29G (29R, 29B) onto the screen SC. A prism PR corresponding to the cross-dichroic prism 31 in FIG. 1 is disposed between the fixed-focus lens 40 and the liquid crystal panel 29G (29R, 29B).

The fixed-focus lens 40 includes a first lens group G1 having positive refractive power or power, an aperture stop ST, and a second lens group G2 having positive refractive power or power, the element sequentially arranged from the side facing the screen SC, which is the enlargement side, toward the reduction side. The configuration in which the first lens group G1 has positive refractive power, can suppress the total length and the maximum diameter of the fixed-focus lens 40.

The fixed-focus lens 40 is a telecentric system on the object side or the reduction side, where the liquid crystal panel 29G (29R, 29B) is disposed. Therefore, when the multiple types of light modulated by the liquid crystal panels 29G, 29R, and 29B are combined with one another in the cross dichroic prism 31 into image light, the light use efficiency can be increased, and variation in element assembly can be readily eliminated. Note that the term telecentric includes a substantially telecentric case where the principal ray is substantially parallel to an optical axis OA.

The first lens group G1 includes lenses 45 to 41 having positive, positive, negative, negative, and negative refractive power or power, respectively, and sequentially arranged from the reduction side. The lenses 45 to 41 are each a single lens or a cemented lens. Specifically, the first lens group G1 includes a first lens 41 having negative refractive power, a second lens 42 having negative refractive power, a third lens 43 having negative refractive power, a fourth lens 44 having positive refractive power, and a fifth lens 45 having positive refractive power, the lenses sequentially arranged from the enlargement side. The first lens group G1 has a configuration in which multiple negative lenses 41n to 43n are disposed on the enlargement side to spread the beams on the enlargement side. The first lens group G1 also has a configuration in which multiple positive lenses 44p and 45p are disposed on the reduction side for size reduction. Larger positive power of the first lens group G1 is suitable for the size reduction, but is not preferable in terms of aberrations. The present configuration, in which two positive lenses are arranged side by side on the reduction side, allows reduction in the amount of aberrations produced per one positive lens, and the size reduction.

In the first lens group G1, one of the first lens 41, which is closest to the enlargement side, and the second lens 42, which is second closest to the enlargement side, is an aspherical lens C1. Since the lens 41, which is closest to the enlargement side, or the lens 42, which is second closest to the enlargement side, is the aspherical lens C1, correction of field curvature and distortion and the size reduction can both be achieved.

The lenses 41 to 45, which constitute the first lens group G1, are made of glass or plastic. The aspherical lens C1 of the first lens group G1 is preferably made of plastic in view of weight reduction and ease of processing. Note that the aspherical lens C1 may be made of glass.

In the example shown in FIG. 2, the first lens 41 is the negative lens 41n configured, for example, with a single lens, and is disposed at a position closest to the enlargement side. The first lens 41 is the aspherical lens C1 made of plastic. The second lens 42 is the negative lens 42n configured, for example, with a single lens. The third lens 43 is the negative lens 43n configured, for example, with a cemented lens 43u. The cemented lens 43u is configured, for example, with the combination of a negative lens 43a and a positive lens 43b sequentially arranged from the enlargement side. The fourth lens 44 is the positive lens 44p configured, for example, with a cemented lens 44u. The cemented lens 44u is configured, for example, with the combination of a positive lens 44a and a negative lens 44b sequentially arranged from the enlargement side. The fifth lens 45 is the positive lens 45p configured, for example, with a single lens.

In the fixed-focus lens 40, it is desirable that any one or two of the lenses 41 to 45 of the first lens group G1 is moved in the optical axis OA direction to performs focusing.

The second lens group G2 includes lenses 51 to 54 and 59 having negative, positive, positive, negative, and positive refractive power or power, respectively, and sequentially arranged from the enlargement side. The lenses 51 to 54 and 59 are each a single lens or a cemented lens. Specifically, the second lens group G2 includes a sixth lens 51 having negative refractive power, a seventh lens 52 having positive refractive power, an eighth lens 53 having positive refractive power, a ninth lens 54 having negative refractive power, and a tenth lens 59 having positive refractive power, the lenses sequentially arranged from the enlargement side. Since the first lens group G1 has positive refractive power, the second lens group G2 employs a configuration in which the sixth lens 51 facing the enlargement side and closest to the first lens group G1 is a negative lens 51n for aberration correction. To reduce the size of the second lens group G2, it is preferable to dispose a lens having large positive refractive power near the aperture stop ST, but this configuration in which a single lens produces the large positive power makes it difficult to correct the aberrations. In view of the difficulty, the seventh lens 52 and the eighth lens 53 in the second lens group G2, which are arranged near the aperture stop ST, are so arranged that the large positive power is distributed to the two lenses. The tenth lens 59 having positive refractive power is disposed at a position facing the reduction side in the second lens group G2 to ensure the telecentricity of the fixed-focus lens 40. Note that the tenth lens 59, which is closest to the reduction side, may be a positive lens group 59g configured with multiple single lenses, multiple cemented lenses, or a combination of a single lens and a cemented lens as long as the positive lens group 59g as a whole has positive refractive power. Furthermore, in the second lens group G2, the ninth lens 54 having negative refractive power is disposed on the enlargement side of the tenth lens 59 for aberration correct required by the addition of the tenth lens 59 described above.

The second lens group G2 includes an aspherical lens C2 having positive refractive power. As a result, astigmatism can be effectively suppressed, and the diameters of the lenses constituting the second lens group G2 and the cost thereof can be reduced as compared with the case where the second lens group G2 is configured only with spherical lenses.

The sixth lens 51 closest to the enlargement side in the second lens group G2 is a negative cemented lens 51u configured with a lens 51a having positive refractive power and a lens 51b having negative refractive power. The fixed-focus lens 40 can thus achieve a wide-angle field of view, size reduction, and suppression of chromatic aberrations.

The lenses 51 to 54 and 59, which constitute the second lens group G2, are made of glass or plastic. The aspherical lens C2 of the second lens group G2 is preferably made of glass in view of light resistance and part costs. Note that the aspherical lens C2 may instead be made of plastic.

In the example shown FIG. 2, the sixth lens 51 is the negative lens 51n configured, for example, with the cemented lens 51u, and is disposed on the enlargement side, that is, a position closest to the aperture stop ST. The cemented lens 51u is configured, for example, with the combination of the positive lens 51a and the negative lens 51b sequentially arranged from the enlargement side. The seventh lens 52 is a positive lens 52p configured, for example, with a single lens, and is the aspherical lens C2 made of glass. The eighth lens 53 is a positive lens 53p configured, for example, with a single lens. The ninth lens 54 is a negative lens 54n configured, for example, with a cemented lens 54u. The cemented lens 54u is configured, for example, with the combination of a negative lens 54a and a positive lens 54b sequentially arranged from the enlargement side. The tenth lens 59 is a positive lens 59p configured, for example, with a single lens. Specifically, the tenth lens 59 is configured, for example, with a positive lens 55 and a positive lens 56. It can also be said that the tenth lens 59 in FIG. 2 is the positive lens group 59g in which two positive single lenses are arranged. Note that the tenth lens 59 may be configured, for example, with a single or cemented lens.

The aperture stop ST is a plane that defines the F number of the fixed-focus lens 40, and is a plane located at a position where the principal ray passes through the optical axis OA. The aperture stop ST may in practice be disposed in the form of a light-blocking aperture member, or may not be disposed.

The fixed-focus lens 40 according to the embodiment satisfies Conditional Expression below.

$$ω > 45 \qquad ( 1 )$$

In Conditional Expression (1), the value ω is the largest half viewing angle of the fixed-focus lens 40. Conditional Expression (1) is an expression showing how to increase the field of view of the fixed-focus lens 40.

The fixed-focus lens 40 according to the embodiment satisfies Conditional Expression below.

$$0.15 < L 1 H / LL < 0.4 \qquad ( 2 )$$

In Conditional Expression (2), the value L1H represents the height of the beam passing through the top of the maximum image height at the lens surface of the fixed-focus lens 40 that is closest to the enlargement side, specifically, an enlargement-side lens surface 41s of the first lens 41, and the value LL represents the length of the fixed-focus lens 40.

Conditional Expression (2) is an expression used to reduce the size of the fixed-focus lens 40 in the height direction, that is, the diameters of the lenses. Setting the value L1H/LL in the conditional expression described above at a value greater than or equal to the lower limit allows favorable correction of the field curvature and the distortion while reducing the size in the height direction. Setting the value L1H/LL in the conditional expression described above at a value smaller than or equal to the upper limit allows suppression of an increase in the height of the fixed-focus lens 40, so that the requirement of the product height can be satisfied.

The fixed-focus lens 40 according to the embodiment satisfies Conditional Expression below.

$$2.5 < BF / F < 3.5 \qquad ( 3 )$$

In Conditional Expression (3), the value BF represents the back focal length in air, and the value F represents the focal length of the entire fixed-focus lens 40.

Conditional expression (3) is an expression used to ensure an appropriate back focal length. Setting the value BF/F in the conditional expression described above at a value greater than or equal to the lower limit can ensure a length necessary for placement of an inserted object such as the prism PR. Setting the value BF/F in the conditional expression described above at a value smaller than or equal to the upper limit can achieve a short lens length and a wide-angle field of view of the fixed-focus lens 40.

The fixed-focus lens 40 according to the embodiment satisfies Conditional Expression below.

$$3. 0 < Fg 1 p / F < 25. \qquad ( 4 )$$

In Conditional Expression (4), the value Fg1p represents the focal length of the lens closest to the reduction side in the first lens group G1, specifically, the fifth lens 45, and the value F represents the focal length of the entire fixed-focus lens 40.

Conditional expression (4) is an expression used to reduce the size of the fixed-focus lens 40 and correct the aberrations produced by the fixed-focus lens 40. Setting the value Fg1p/F in the conditional expression described above at a value greater than or equal to the lower limit allows advantageous aberration correction while maintaining the size reduction. Setting the value Fg1p/F in the conditional expression described above at a value smaller than or equal to the upper limit can achieve the size reduction while allowing the advantageous aberration correction.

The fixed-focus lens 40 according to the embodiment satisfies Conditional Expression below.

$$0.2 < Fg 2 p 1 / Fg 2 p 2 < 1.2 \qquad ( 5 )$$

In Conditional Expression (5), the value Fg2p1 represents the focal length of a positive single lens or a positive cemented lens disposed at a position closest to the enlargement side in the second lens group G2, specifically, the seventh lens 52, and the value Fg2p2 represents the focal length of a positive single lens or a positive cemented lens disposed at a position second closest to the enlargement side in the second lens group G2, specifically, the eighth lens 53.

Conditional expression (5) shows how the power is distributed to the two enlargement-side positive lenses in the second lens group G2. Satisfying Conditional Expression (5) allows favorable correction of the various aberrations caused by the reduction in size of the fixed-focus lens 40 and the increase in the wide-angle field of view thereof.

The fixed-focus lens 40 according to the embodiment satisfies Conditional Expression below.

$$0.8 < \vert Fg 2 n 1 / Fg 2 p 3 - \vert < 2.8 \qquad ( 6 )$$

In Conditional Expression (6), the value Fg2n1 represents the focal length of a negative single lens or a negative cemented lens disposed at a position closest to the reduction side in the second lens group G2, specifically, the ninth lens 54, and the value Fg2p3− represents the focal length of a positive single lens or a positive cemented lens disposed at a position closest to the reduction side in the second lens group G2, specifically, a positive lens shifted from the ninth lens 54 toward the reduction side, more specifically, the tenth lens 59. The aforementioned positive lens shifted toward the reduction side includes one or more single lenses or cemented lenses.

Conditional expression (6) is an expression used to ensure the telecentricity and correct the chromatic aberration of magnification. Setting the value Fg2n1/Fg2p3− of the conditional expression described above at a value greater than or equal to the lower limit can ensure the telecentricity. Setting the value Fg2n1/Fg2p3− of the conditional expression described above at a value smaller than or equal to the upper limit allows favorable correction of the chromatic aberration of magnification.

The fixed-focus lens 40 according to the embodiment satisfies Conditional Expression below.

$$0.45 < LS / LL < 0.65 \qquad ( 7 )$$

In Conditional Expression (7), the value LS represents the distance from the lens surface of the fixed-focus lens 40 that is closest to the enlargement side, specifically, the lens surface 41s of the first lens 41 to the aperture stop ST, and the value LL represents the length of the fixed-focus lens 40.

Conditional Expression (7) is an expression relating to reducing the diameters of the lenses and ensuring the telecentricity. Setting the value LS/LL of the conditional expression described above at a value greater than or equal to the lower limit can ensure the telecentricity. Setting the value LS/LL in the conditional expression described above at a value smaller than or equal to the upper limit allows reduction in the diameters of the lenses.

The fixed-focus lens 40 described above includes the first lens group G1, the aperture stop ST, and the second lens group G2 sequentially arranged from the enlargement side toward the reduction side, the first lens group G1 and the second lens group G2 each having positive refractive power. In the first lens group G1, the lens 41 closest to the enlargement side or the lens 42 second closest to the enlargement side is the aspherical lens C1, and the reduction side of the fixed-focus lens 40 is a telecentric system. The fixed-focus lens 40 satisfies the conditional expressions below.

$$\begin{matrix}ω > 45 \\ 0.15 < L 1 H / LL < 0. 4 \\ 2.5 < BF / F < 3.5\end{matrix} \qquad ( 3 )$$

In the conditional expressions described above, the value ω represents the largest half viewing angle of the fixed-focus lens 40, the value L1H represents the height of the beam passing through the top of the maximum image height at the lens surface of the fixed-focus lens 40 that is closest to the enlargement side, the value LL is the length of the fixed-focus lens 40, the value BF represents the back focal length in air, and the value F represents the focal length of the entire fixed-focus lens 40.

In the fixed-focus lens 40 described above, setting the refractive power of the first lens group G1 at a positive value can suppress the total length and the maximum diameter of the fixed-focus lens 40. Since the lens 41, which is closest to the enlargement side, or the lens 42, which is second closest to the enlargement side, is the aspherical lens C1, correction of field curvature and distortion and the size reduction can both be achieved.

Conditional Expression (1) is an expression showing how to increase the field of view of the fixed-focus lens 40. Conditional expression (2) is an expression used to reduce the size of the fixed-focus lens 40 in the height direction. Setting the value L1H/LL in the conditional expressions described above at a value greater than or equal to the lower limit allows favorable correction of the field curvature and the distortion while reducing the size in the height direction. Setting the value L1H/LL in the conditional expressions described above at a value smaller than or equal to the upper limit allows suppression of an increase in the height of the fixed-focus lens 40, so that the requirement of the product height can be satisfied. Conditional expression (3) is an expression used to ensure an appropriate back focal length. Setting the value BF/F in the conditional expressions described above at a value greater than or equal to the lower limit can ensure a length necessary for placement of an inserted object such as the prism PR. Setting the value BF/F in the conditional expressions described above at a value smaller than or equal to the upper limit can achieve a short lens length and a wide-angle field of view of the fixed-focus lens 40.

As described above, the fixed-focus lens 40 is a small projection lens that provides a bright, high-quality image and even has a wide-angle of field of view. That is, the fixed-focus lens 40 can achieve both a wide-angle of field of view corresponding to a viewing angle of 90 degrees or greater and size reduction, and can favorably correct various aberrations. Accordingly, the product size can be reduced, and the cost of the product can be suppressed without deterioration in the resolution performance.

The projector 2 described above includes the image forming section 20a including the light modulator OM, which modulates the light from the light source apparatus 10 to form image light, and the abovementioned fixed-focus lens 40, which projects the image light from the image forming section 20a. The size of the projector 2 including the fixed-focus lens 40 can thus be reduced.

### EXAMPLES

Examples of the fixed-focus lens 40 will be described below. The meanings of specifications common to Examples 1 to 4, which will be described below, are summarized below.
F: Focal length of entire fixed-focus lens 40
Fno: F-number
IH: Maximum height of image produced by lens
TTL: Distance from lens surface 41s of fixed-focus lens 40 that is closest to enlargement side to original image
LL: Length of fixed-focus lens 40 (distance from lens surface 41s of fixed-focus lens 40 that is closest to enlargement side to last surface of fixed-focus lens 40)
BF: Back focal length in air
LS: Distance from lens surface 41s of fixed-focus lens 40 that is closest to enlargement side to aperture stop ST
L1H: Height of beam passing through top of maximum image height at lens surface 41s of fixed-focus lens 40 that is closest to enlargement side
FG1: Focal length of first lens group G1
FG2: Focal length of second lens group G2
R: Paraxial radius of curvature
D: Axial inter-surface spacing (lens thickness or lens spacing)
Nd: Refractive index at d-line (reference wavelength: 588 nm)
Vd: Abbe number at d-line (reference wavelength: 588 nm)

The amount of displacement z at an aspherical surface is specified by the following polynomial (aspherical surface expression).

$$z = \frac{{ch}^{2}}{1 + \sqrt{1 - ( k + 1 ) {c}^{2} {h}^{2}}} + \sum {A}_{i} {h}^{i}$$

In the polynomial,
c: Curvature (1/R)
H: Height from optical axis OA
K: Conic constant of aspherical surface
Ai: i-th aspherical coefficient

Note that in the table of each example, the surface number 0 means the image plane (projection receiving surface) on the screen SC, “ST” means the aperture stop ST, “INF” means infinity, and the last surface number means the display surface such as the liquid crystal panel 29G. A surface with a surface number followed by “*” is an aspherical surface.

### Example 1

The overall specifications of the fixed-focus lens 40 according to Example 1 are shown below.
F=7.733 (mm)
Fno=1.787
IH=11.000 (mm)
TTL=143.235 (mm)
LL=108.290 (mm)
BF=25.729 (mm)
LS=54.091 (mm)
L1H=17.778 (mm)
FG1=100.000 (mm)
FG2=28.467 (mm)

Data on the lens surfaces in Example 1 are shown in Table 1 below.

TABLE 1

| Surface number | R | D | Nd | Vd |
|---|---|---|---|---|
| 0 | inf | 970.00 | | |
| 1* | −8.01 | 3.00 | 1.5350 | 55.7 |
| 2* | −15.20 | 3.35 | | |
| 3 | 33.48 | 1.50 | 1.9108 | 35.3 |
| 4 | 15.14 | 9.97 | | |
| 5 | −25.11 | 0.90 | 1.9534 | 31.3 |
| 6 | 23.27 | 9.00 | 1.8052 | 25.5 |
| 7 | −28.25 | 1.09 | | |
| 8 | 157.09 | 9.00 | 1.6477 | 33.9 |
| 9 | −14.71 | 0.90 | 1.9108 | 35.3 |
| 10 | −43.95 | 3.87 | | |
| 11 | −208.19 | 9.00 | 1.7080 | 27.0 |
| 12 | −35.88 | 2.50 | | |
| 13 (ST) | inf | 2.67 | | |
| 14 | −70.32 | 9.00 | 1.8720 | 19.4 |
| 15 | −17.76 | 0.90 | 1.9537 | 32.3 |
| 16 | 46.53 | 0.52 | | |
| 17* | 21.93 | 7.69 | 1.5158 | 64.0 |
| 18* | −23.50 | 0.25 | | |
| 19 | −163.74 | 5.27 | 1.4875 | 70.2 |
| 20 | −23.13 | 1.00 | | |
| 21 | −50.58 | 1.00 | 1.9533 | 31.0 |
| 22 | 19.88 | 7.41 | 1.4970 | 81.6 |
| 23 | −70.37 | 0.25 | | |
| 24 | 58.92 | 9.00 | 1.4970 | 81.5 |
| 25 | −32.51 | 0.25 | | |
| 26 | 200.00 | 9.00 | 1.4970 | 81.6 |
| 27 | −45.21 | 2.00 | | |
| 28 | inf | 27.05 | 1.5168 | 64.2 |
| 29 | inf | 5.89 | | |
| 30 | inf | 0.00 | | |

Table 2 below shows the aspherical coefficients of the lens surfaces in Example 1. In Table 2 and the tables shown below, a number to the power of 10 (1.00×10+18, for example) is expressed by using E (1.00E+18, for example).

TABLE 2
Aspherical coefficients

| K | A3 | A4 | A5 | A6 | A7 | A8 | A9 | A10 |
|---|---|---|---|---|---|---|---|---|
| Surface | | | | | | | | |
| number: 1 | | | | | | | | |
| −3.58126E+00 | 2.88609E−03 | 1.03740E−04 | −3.32812E−05 | 2.26227E−06 | −6.15336E−08 | 3.30677E−11 | 3.16484E−11 | −4.49379E−13 |
| Surface | | | | | | | | |
| number: 2 | | | | | | | | |
| −2.33776E+00 | 1.65997E−03 | 8.35030E−04 | −1.03708E−04 | 6.58898E−06 | −4.24075E−07 | 2.57433E−09 | −1.24458E−09 | 1.92977E−11 |

| K | A4 | A6 | A8 | A10 |
|---|---|---|---|---|
| Surface | | | | |
| number: 17 | | | | |
| 0.00000E+00 | −1.91954E−03 | 2.11260E−08 | −3.87908E−10 | 1.33369E−12 |
| Surface | | | | |
| number: 18 | | | | |
| −9.75759E+00 | −5.74762E−05 | 5.03735E−07 | −2.27919E−09 | 5.16313E−12 |

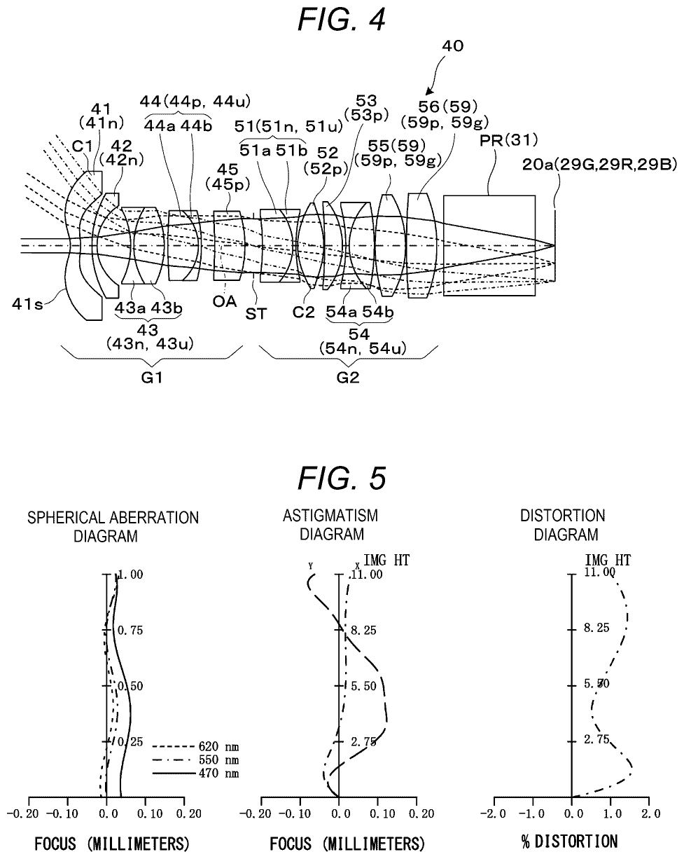

FIG. 4 is a cross-sectional view of the fixed-focus lens 40 according to Example 1. The fixed-focus lens 40 shown in FIG. 4 corresponds to the fixed-focus lens 40 according to the embodiment.

The fixed-focus lens 40 enlarges an image on the display surface, for example, of the liquid crystal panel 29G and projects the enlarged image onto the screen SC (see FIG. 3). The fixed-focus lens 40 includes the first lens group G1, the aperture stop ST, and the second lens group G2 sequentially arranged from the side facing the screen SC, which is the enlargement side, the first lens group G1 and the second lens group G2 each having positive refractive power. The prism PR is disposed between the second lens group G2 and the liquid crystal panel 29G. The reduction side of the fixed-focus lens 40 is a substantially telecentric system.

The first lens group G1 includes the first lens 41, the second lens 42, the third lens 43, the fourth lens 44, and the fifth lens 45 sequentially arranged from the enlargement side. The first lens 41 is the negative aspherical lens C1 made of plastic (negative lens 41n). The second lens 42 is a negative meniscus lens (negative lens 42n). The third lens 43 is the negative cemented lens 43u (negative lens 43n) configured with a biconcave lens (negative lens 43a) and a biconvex lens (positive lens 43b). The fourth lens 44 is the positive cemented lens 44u (positive lens 44p) configured with a biconvex lens (positive lens 44a) and a negative meniscus lens (negative lens 44b). The fifth lens 45 is a positive meniscus lens (positive lens 45p).

The second lens group G2 is configured with the sixth lens 51, the seventh lens 52, the eighth lens 53, the ninth lens 54, and the tenth lens 59 sequentially arranged from the enlargement side. The sixth lens 51 is the negative cemented lens 51u (negative lens 51n) configured with a positive meniscus lens (positive lens 51a) and a biconcave lens (negative lens 51b). The seventh lens 52 is the biconvex aspherical lens C2 (positive lens 52p) made of glass. The eighth lens 53 is a positive meniscus lens (positive lens 53p). The ninth lens 54 is the negative cemented lens 54u (negative lens 54n) configured with a biconcave lens (negative lens 54a) and a biconvex lens (positive lens 54b). The tenth lens 59 is configured, as the positive lens group 59g, with a biconvex lens (positive lens 59p or positive lens 55) and a biconvex lens (positive lens 59p or positive lens 56).

FIG. 5 shows the characteristics of the longitudinal aberrations (that is, characteristics of spherical aberration, astigmatism, and distortion) produced by the fixed-focus lens 40 according to Example 1.

### Example 2

The overall specifications of the fixed-focus lens 40 according to Example 2 are shown below.
F=7.663 (mm)
Fno=1.785
IH=11.000 (mm)
TTL=118.514 (mm)
LL=83.569 (mm)
BF=25.730 (mm)
LS=44.165 (mm)
L1H=22.585 (mm)
FG1=100.000 (mm)
FG2=25.123 (mm) Data on the lens surfaces in Example 2 are shown

in Table 3 below.

TABLE 3

| Surface number | R | D | Nd | Vd |
|---|---|---|---|---|
| 0 | inf | 970.00 | | |
| 1* | −7.55 | 3.42 | 1.5350 | 55.7 |
| 2* | −12.68 | 9.55 | | |
| 3 | 37.85 | 1.50 | 1.9537 | 32.3 |
| 4 | 13.92 | 9.94 | | |
| 5 | −22.44 | 0.90 | 1.9537 | 32.3 |
| 6 | −33.60 | 2.31 | 1.7454 | 23.4 |
| 7 | −28.16 | 1.08 | | |
| 8 | −1394.43 | 5.78 | 1.6690 | 28.0 |
| 9 | −11.95 | 0.90 | 1.9537 | 32.3 |
| 10 | −32.48 | 3.44 | | |
| 11 | 80.96 | 2.84 | 1.9459 | 18.0 |
| 12 | −64.39 | 2.50 | | |
| 13 (ST) | inf | 2.50 | | |
| 14 | −47.16 | 3.29 | 1.9127 | 18.6 |
| 15 | −17.50 | 0.90 | 1.9537 | 32.3 |
| 16 | 45.77 | 1.22 | | |
| 17* | 24.21 | 6.13 | 1.5158 | 64.0 |
| 18* | −25.76 | 0.25 | | |
| 19 | −194.36 | 3.68 | 1.4875 | 70.2 |
| 20 | −31.13 | 1.00 | | |
| 21 | −125.92 | 1.00 | 1.9505 | 24.2 |
| 22 | 18.81 | 6.76 | 1.4970 | 81.6 |
| 23 | −66.61 | 0.25 | | |
| 24 | 68.16 | 5.49 | 1.4970 | 81.6 |
| 25 | −42.99 | 0.25 | | |
| 26 | 39.07 | 6.68 | 1.4970 | 81.6 |
| 27 | −57.15 | 2.00 | | |
| 28 | inf | 27.05 | 1.5168 | 64.2 |
| 29 | inf | 5.85 | | |
| 30 | inf | 0.04 | | |

Table 4 below shows the aspherical coefficients of the lens surfaces in Example 2.

TABLE 4
Aspherical coefficients

| K | A3 | A4 | A5 | A6 | A7 | A8 | A9 | A10 |
|---|---|---|---|---|---|---|---|---|
| Surface | | | | | | | | |
| number: 1 | | | | | | | | |
| −3.11235E+00 | 2.73650E−03 | 1.03311E−04 | −3.36563E−05 | 2.29126E−06 | −6.12689E−08 | 1.06250E−11 | 3.07311E−11 | −4.32293E−13 |
| Surface | | | | | | | | |
| number: 2 | | | | | | | | |
| −1.37283E+00 | 1.75145E−03 | 8.24746E−04 | −1.04177E−04 | 6.59256E−06 | −4.22368E−07 | 2.96700E−06 | −1.23958E−09 | 1.93863E−12 |

| K | A4 | A6 | A8 | A10 |
|---|---|---|---|---|
| Surface | | | | |
| number: 17 | | | | |
| 0.00000E+00 | −9.56393E−06 | −4.89369E−06 | 1.74357E−10 | 2.22888E−13 |
| Surface | | | | |
| number: 18 | | | | |
| −1.07408E+01 | −6.2670EE−05 | 4.29080E−07 | −2.33075E−09 | 7.04869E−12 |

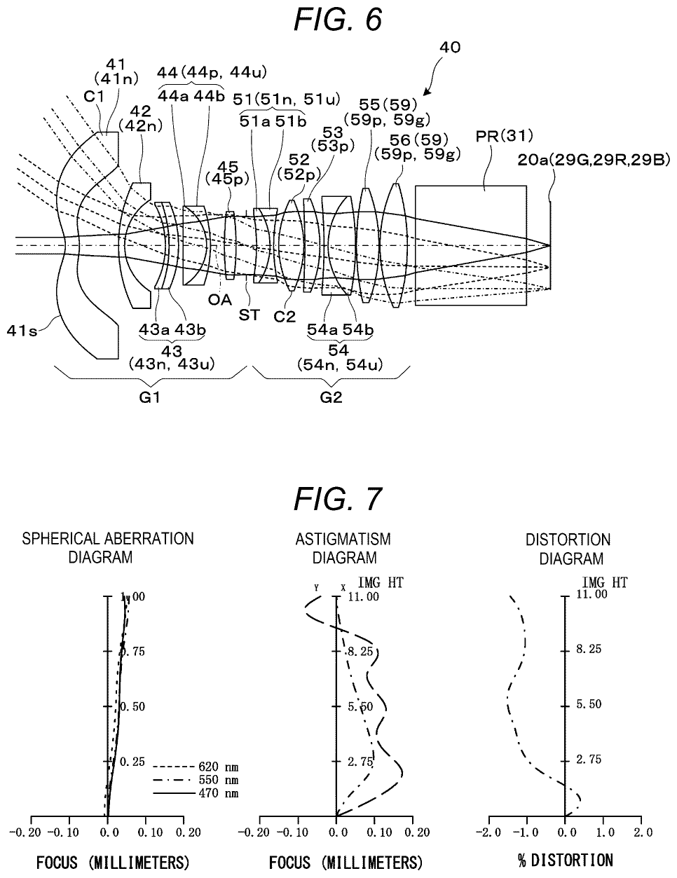

FIG. 6 is a cross-sectional view of the fixed-focus lens 40 according to Example 2.

The fixed-focus lens 40 enlarges an image on the display surface, for example, of the liquid crystal panel 29G and projects the enlarged image onto the screen SC (see FIG. 3). The fixed-focus lens 40 includes the first lens group G1, the aperture stop ST, and the second lens group G2 sequentially arranged from the side facing the screen SC, which is the enlargement side, the first lens group G1 and the second lens group G2 each having positive refractive power. The prism PR is disposed between the second lens group G2 and the liquid crystal panel 29G. The reduction side of the fixed-focus lens 40 is a substantially telecentric system.

The first lens group G1 includes the first lens 41, the second lens 42, the third lens 43, the fourth lens 44, and the fifth lens 45 sequentially arranged from the enlargement side. The first lens 41 is the negative aspherical lens C1 made of plastic (negative lens 41n). The second lens 42 is a negative meniscus lens (negative lens 42n). The third lens 43 is the negative cemented lens 43u (negative lens 43n) configured with a negative meniscus lens (negative lens 43a) and a positive meniscus lens (positive lens 43b). The fourth lens 44 is the positive cemented lens 44u (positive lens 44p) configured with a positive meniscus lens (positive lens 44a) and a negative meniscus lens (negative lens 44b). The fifth lens 45 is a biconvex lens (positive lens 45p). The second lens group G2 is configured with the sixth lens 51, the seventh lens 52, the eighth lens 53, the from the enlargement side. The sixth lens 51 is the negative cemented lens 51u (negative lens 51n) configured with a positive meniscus lens (positive lens 51a) and a biconcave lens (negative lens 51b). The seventh lens 52 is the biconvex aspherical lens C2 (positive lens 52p) made of glass. The eighth lens 53 is a positive meniscus lens (positive lens 53p). The ninth lens 54 is the negative cemented lens 54u (negative lens 54n) configured with a biconcave lens (negative lens 54a) and a biconvex lens (positive lens 54b). The tenth lens 59 is configured, as the positive lens group 59g, with a biconvex lens (positive lens 59p or positive lens 55) and a biconvex lens (positive lens 59p or positive lens 56).

FIG. 7 shows the characteristics of the longitudinal aberrations (that is, characteristics of spherical aberration, astigmatism, and distortion) produced by the fixed-focus lens 40 according to Example 2.

### Example 3

The overall specifications of the fixed-focus lens 40 according to Example 3 are shown below.
F=7.723 (mm)
Fno=1.770
IH=11.000 (mm)
TTL=138.779 (mm)
LL=103.834 (mm)
BF=25.433 (mm)
LS=58.044 (mm)
L1H=20.478 (mm)
FG1=100.000 (mm)
FG2=29.427 (mm)

Data on the lens surfaces in Example 3 are shown in Table 5 below.

TABLE 5

| Surface number | R | D | Nd | Vd |
|---|---|---|---|---|
| 0 | inf | 970.00 | | |
| 1* | −8.34 | 3.16 | 1.5350 | 55.7 |
| 2* | −15.43 | 6.44 | | |
| 3 | 40.44 | 1.50 | 1.9108 | 35.3 |
| 4 | 16.25 | 10.95 | | |
| 5 | −23.58 | 0.90 | 1.9528 | 29.4 |
| 6 | 20.05 | 10.05 | 1.8052 | 25.5 |
| 7 | −26.52 | 1.52 | | |
| 8 | 43.41 | 7.68 | 1.6477 | 33.9 |
| 9 | −17.17 | 1.50 | 1.9108 | 35.3 |
| 10 | −48.02 | 4.32 | | |
| 11 | −26.39 | 7.53 | 1.6089 | 34.4 |
| 12 | −22.87 | 2.50 | | |
| 13 (ST) | inf | 2.50 | | |
| 14 | −140.97 | 7.80 | 1.7190 | 24.7 |
| 15 | −15.20 | 1.20 | 1.9532 | 30.6 |
| 16 | −87.61 | 1.86 | | |
| 17* | −488.26 | 6.75 | 1.5831 | 59.5 |
| 18* | −23.13 | 0.36 | | |
| 19 | −1274.80 | 6.18 | 1.4875 | 70.2 |
| 20 | −18.96 | 1.00 | | |
| 21 | −24.81 | 0.90 | 1.9536 | 31.9 |
| 22 | 27.02 | 8.12 | 1.4970 | 81.6 |
| 23 | −28.05 | 0.25 | | |
| 24 | 49.94 | 8.86 | 1.4970 | 81.6 |
| 25 | −27.91 | 2.00 | | |
| 26 | inf | 27.92 | 1.5168 | 64.2 |
| 27 | inf | 5.06 | | |
| 28 | inf | −0.04 | | |

Table 6 below shows the aspherical coefficients of the lens surfaces in Example 3.

TABLE 6
Aspherical coefficients

| K | A3 | A4 | A5 | A6 | A7 | A8 | A9 | A10 |
|---|---|---|---|---|---|---|---|---|
| Surface | | | | | | | | |
| number: 1 | | | | | | | | |
| −3.99905E+00 | 1.72316E−03 | 2.76621E−04 | −4.66566E−05 | 2.70680E−06 | −6.15956E−03 | −3.21503E−10 | 3.86939E−11 | −4.87310E−13 |
| Surface | | | | | | | | |
| number: 2 | | | | | | | | |
| −4.65649E+00 | 8.09638E−04 | 8.66766E−04 | −1.07594E−04 | 6.72213E−06 | −4.26697E−07 | 2.96113E−06 | −1.22653E−09 | 1.91298E−12 |

| K | A4 | A6 | A8 | A10 |
|---|---|---|---|---|
| Surface | | | | |
| number: 17 | | | | |
| 0.00000E+00 | −1.11194E−06 | −1.60113E−08 | 8.89281E−10 | −7.60260E−12 |
| Surface | | | | |
| number: 18 | | | | |
| −7.64631E+00 | −4.42317E−05 | 3.00047E−07 | −2.71940E−10 | −2.16604E−12 |

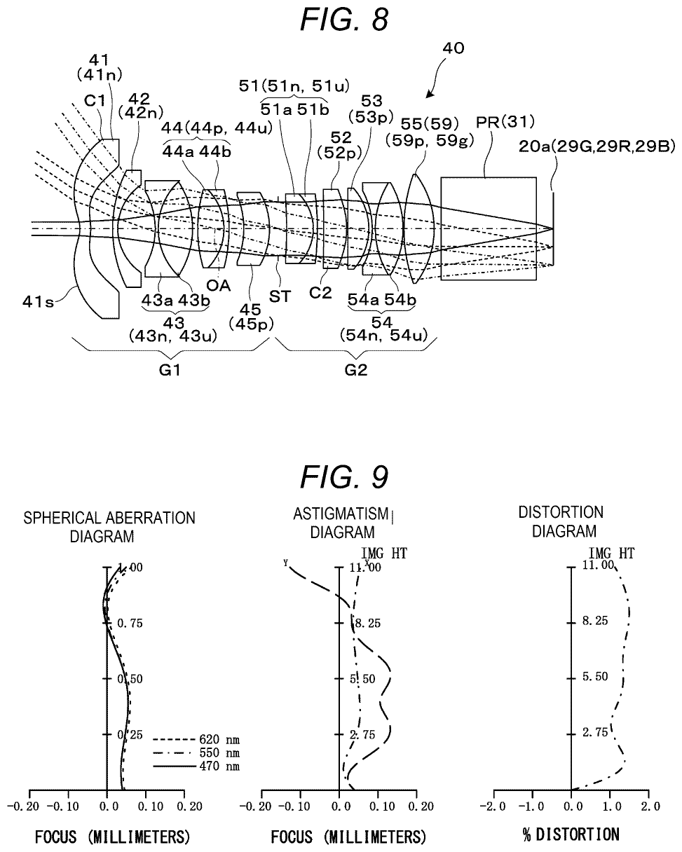

FIG. 8 is a cross-sectional view of the fixed-focus lens 40 according to Example 3.

The fixed-focus lens 40 enlarges an image on the display surface, for example, of the liquid crystal panel 29G and projects the enlarged image onto the screen SC (see FIG. 3). The fixed-focus lens 40 includes the first lens group G1, the aperture stop ST, and the second lens group G2 sequentially arranged from the side facing the screen SC, which is the enlargement side, the first lens group G1 and the second lens group G2 each having positive refractive power. The prism PR is disposed between the second lens group G2 and the liquid crystal panel 29G. The reduction side of the fixed-focus lens 40 is a substantially telecentric system.

The first lens group G1 includes the first lens 41, the second lens 42, the third lens 43, the fourth lens 44, and the fifth lens 45 sequentially arranged from the enlargement side. The first lens 41 is the negative aspherical lens C1 made of plastic (negative lens 41n). The second lens 42 is a negative meniscus lens (negative lens 42n). The third lens 43 is the negative cemented lens 43u (negative lens 43n) configured with a biconcave lens (negative lens 43a) and a biconvex lens (positive lens 43b). The fourth lens 44 is the positive cemented lens 44u (positive lens 44p) configured with a biconvex lens (positive lens 44a) and a negative meniscus lens (negative lens 44b). The fifth lens 45 is a positive meniscus lens (positive lens 45p). The second lens group G2 is configured with the sixth lens 51, the seventh lens 52, the eighth lens 53, the from the enlargement side. The sixth lens 51 is the negative cemented lens 51u (negative lens 51n) configured with a positive meniscus lens (positive lens 51a) and a negative meniscus lens (negative lens 51b). The seventh lens 52 is the positive meniscus aspherical lens C2 (positive lens 52p) made of glass. The eighth lens 53 is a positive meniscus lens (positive lens 53p). The ninth lens 54 is the negative cemented lens 54u (negative lens 54n) configured with a biconcave lens (negative lens 54a) and a biconvex lens (positive lens 54b). The tenth lens 59 is configured, as the positive lens group 59g, with a biconvex lens (positive lens 59p or positive lens 55).

FIG. 9 shows the characteristics of the longitudinal aberrations (that is, characteristics of spherical aberration, astigmatism, and distortion) produced by the fixed-focus lens 40 according to Example 3.

### Example 4

The overall specifications of the fixed-focus lens 40 according to Example 4 are shown below.
F=7.721 (mm)
Fno=1.770
IH=11.000 (mm)
TTL=125.559 (mm)
LL=90.614 (mm)
BF=25.433 (mm)
LS=53.086 (mm)
L1H=18.638 (mm)
FG1=18.593 (mm)
FG2=28.872 (mm)

Data on the lens surfaces in Example 4 are shown in Table 7 below.

TABLE 7

| Surface number | R | D | Nd | Vd |
|---|---|---|---|---|
| 0 | inf | 970.00 | | |
| 1* | −8.36 | 3.00 | 1.5350 | 55.7 |
| 2* | −14.06 | 3.88 | | |
| 3 | 58.16 | 1.50 | 1.9435 | 35.3 |
| 4 | 15.18 | 13.09 | | |
| 5 | −17.50 | 0.90 | 1.6087 | 63.6 |
| 6 | 61.49 | 7.71 | 1.7958 | 26.6 |
| 7 | −33.77 | 1.13 | | |
| 8 | 66.42 | 7.65 | 1.6462 | 30.0 |
| 9 | −14.59 | 1.50 | 1.9290 | 33.5 |
| 10 | −58.48 | 4.69 | | |
| 11 | 41.73 | 5.52 | 1.5096 | 68.9 |
| 12 | −27.65 | 2.50 | | |
| 13 (ST) | inf | 2.50 | | |
| 14 | −35.21 | 4.85 | 1.8091 | 21.1 |
| 15 | −13.72 | 1.20 | 1.9441 | 32.8 |
| 16 | 62.50 | 0.83 | | |
| 17* | 29.00 | 5.14 | 1.5831 | 59.5 |
| 18* | −26.71 | 0.46 | | |
| 19 | −71.15 | 4.73 | 1.4875 | 70.2 |
| 20 | −18.56 | 1.00 | | |
| 21 | −42.67 | 0.90 | 1.9350 | 32.9 |
| 22 | 23.07 | 7.78 | 1.4970 | 81.6 |
| 23 | −28.86 | 0.25 | | |
| 24 | 47.10 | 7.89 | 1.4970 | 81.6 |
| 25 | −28.01 | 2.00 | | |
| 26 | inf | 27.92 | 1.5168 | 64.2 |
| 27 | inf | 5.05 | | |
| 28 | inf | −0.03 | | |

Table 8 below shows the aspherical coefficients of the lens surfaces in Example 4.

TABLE 8
Aspherical coefficients

| K | A3 | A4 | A5 | A6 | A7 | A8 | A9 | A10 |
|---|---|---|---|---|---|---|---|---|
| Surface | | | | | | | | |
| number: 1 | | | | | | | | |
| −3.39154E+00 | 2.15602E−03 | 2.41356E−04 | −4.48586E−05 | 2.70605E−06 | −6.28296E−08 | −3.61127E−10 | 3.98374E−11 | −4.36003E−13 |
| Surface | | | | | | | | |
| number: 2 | | | | | | | | |
| −1.60057E+00 | 9.94345E−04 | 8.85844E−04 | −1.05953E−04 | 6.67814E−06 | −4.30964E−07 | 2.95958E−08 | −1.23045E−09 | 1.99243E−11 |

| K | A4 | A6 | A8 | A10 |
|---|---|---|---|---|
| Surface | | | | |
| number: 17 | | | | |
| 0.00000E+00 | −5.57911E−06 | 6.47592E−08 | −8.97472E−11 | 2.25827E−18 |
| Surface | | | | |
| number: 18 | | | | |
| −9.64465E+00 | −7.34991E−06 | 3.68708E−07 | −9.53547E−10 | 1.54239E−12 |

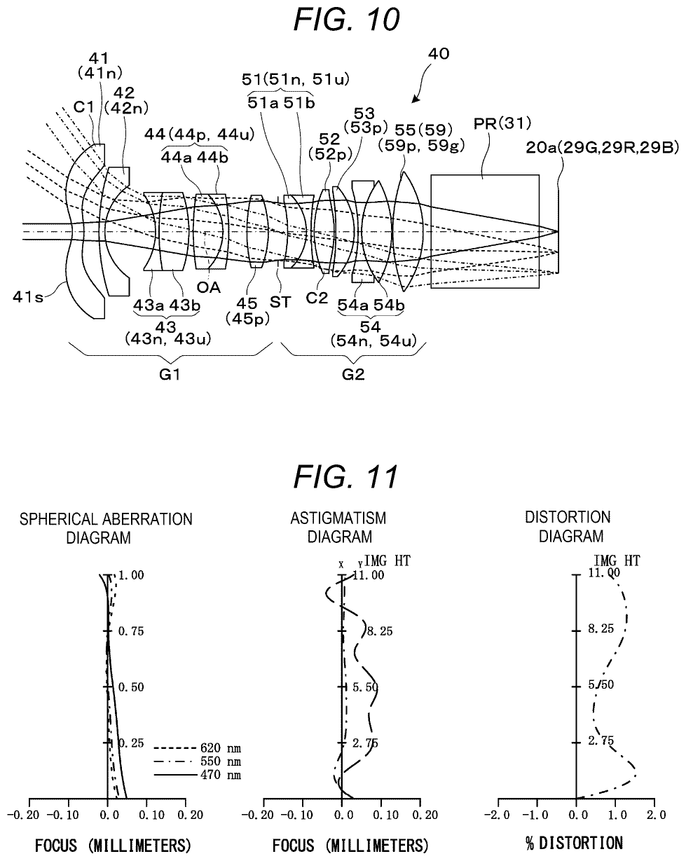

FIG. 10 is a cross-sectional view of the fixed-focus lens 40 according to Example 4.

The fixed-focus lens 40 enlarges an image on the display surface, for example, of the liquid crystal panel 29G and projects the enlarged image onto the screen SC (see FIG. 3). The fixed-focus lens 40 includes the first lens group G1, the aperture stop ST, and the second lens group G2 sequentially arranged from the side facing the screen SC, which is the enlargement side, the first lens group G1 and the second lens group G2 each having positive refractive power. The prism PR is disposed between the second lens group G2 and the liquid crystal panel 29G. The reduction side of the fixed-focus lens 40 is a substantially telecentric system.

The first lens group G1 includes the first lens 41, the second lens 42, the third lens 43, the fourth lens 44, and the fifth lens 45 sequentially arranged from the enlargement side. The first lens 41 is the negative aspherical lens C1 made of plastic (negative lens 41n). The second lens 42 is a negative meniscus lens (negative lens 42n). The third lens 43 is the negative cemented lens 43u (negative lens 43n) configured with a biconcave lens (negative lens 43a) and a biconvex lens (positive lens 43b). The fourth lens 44 is the positive cemented lens 44u (positive lens 44p) configured with a biconvex lens (positive lens 44a) and a negative meniscus lens (negative lens 44b). The fifth lens 45 is a biconvex lens (positive lens 45p).

The second lens group G2 is configured with the sixth lens 51, the seventh lens 52, the eighth lens 53, the from the enlargement side. The sixth lens 51 is the negative cemented lens 51u (negative lens 51n) configured with a positive meniscus lens (positive lens 51a) and a biconcave lens (negative lens 51b). The seventh lens 52 is the biconvex aspherical lens C2 (positive lens 52p) made of glass. The eighth lens 53 is a positive meniscus lens (positive lens 53p). The ninth lens 54 is the negative cemented lens 54u (negative lens 54n) configured with a biconcave lens (negative lens 54a) and a biconvex lens (positive lens 54b). The tenth lens 59 is configured, as the positive lens group 59g, with a biconvex lens (positive lens 59p or positive lens 55).

FIG. 11 shows the characteristics of the longitudinal aberrations (that is, characteristics of spherical aberration, astigmatism, and distortion) produced by the fixed-focus lens 40 according to Example 4.

For reference, the following Table 9 shows Examples 1 to 4 corresponding to Conditional Expressions (1) to (7).

TABLE 9

| | Example 1 | Example 2 | Example 3 | Example 4 |
|---|---|---|---|---|
| Value ω in | 54.522 | 55.324 | 54.448 | 54.536 |
| Conditional | | | | |
| Expression (1) | | | | |
| Value L1H/LL in | 0.164 | 0.302 | 0.197 | 0.206 |
| Conditional | | | | |
| Expression (2) | | | | |
| Value BF/F in | 3.327 | 3.458 | 3.293 | 3.294 |
| Conditional | | | | |
| Expression (3) | | | | |
| Value Fg1p/F in | 7.690 | 3.786 | 20.000 | 4.331 |
| Conditional | | | | |
| Expression (4) | | | | |
| Value Fg2p1/Fg2p2 in | 0.428 | 0.226 | 1.050 | 0.503 |
| Conditional | | | | |
| Expression (5) | | | | |
| Value \|Fg2n1/Fg2p3−\| | 1.009 | 2.579 | 0.822 | 1.350 |
| in Conditional | | | | |
| Expression (6) | | | | |
| Value LS/LL in | 0.499 | 0.536 | 0.559 | 0.585 |
| Conditional | | | | |
| Expression (7) | | | | |

### Other Items

The structure described above is presented by way of example, and can be changed in various manners to the extent that the same functions can be achieved.

For example, in each of Examples, one or more lenses having substantially no power can be added at each of positions upstream and downstream from the lenses that constitute each of the lens groups G1 and G2.

Furthermore, a target to be enlarged and projected by the fixed-focus lens 40 is not limited to an image formed by a liquid crystal panel, and an image formed by any other light modulator such as a digital micromirror device can be enlarged and projected.

### Summary of Present Disclosure

The present disclosure is summarized below as additional remarks.

### Additional Remark 1

A fixed-focus lens including: a first lens group; an aperture stop; and a second lens group sequentially arranged from an enlargement side toward a reduction side, the first and second lens groups each having positive refractive power, wherein
a lens closest to the enlargement side or a lens second closest to the enlargement side in the first lens group is an aspherical lens,
the reduction side of the fixed-focus lens is a telecentric system, and
the fixed-focus lens satisfies conditional expressions below,

$$ω > 45 \qquad ( 1 )$$

$$0.15 < L 1 H / LL < 0. 4 \qquad ( 2 )$$

$$2.5 < BF / F < 3.5 \qquad ( 3 )$$

where
ω: Largest half viewing angle of fixed-focus lens,
L1H: Height of beam passing through top of maximum image height at lens surface of fixed-focus lens that is closest to enlargement side,
LL: Length of fixed-focus lens,
BF: Back focal length in air, and
F: Focal length of entire system of fixed-focus lens.

In the fixed-focus lens described above, setting the refractive power of the first lens group at a positive value can suppress the total length and the maximum diameter of the fixed-focus lens. Since the lens that is closest to the enlargement side or the lens that is second closest to the enlargement side is an aspherical lens, correction of field curvature and distortion and the size reduction can both be achieved.

Conditional Expression (1) is an expression showing how to increase the field of view of the fixed-focus lens.

Conditional expression (2) is an expression used to reduce the size of the fixed-focus lens in the height direction. Setting the value L1H/LL in the conditional expressions described above at a value greater than or equal to the lower limit allows favorable correction of the field curvature and the distortion while reducing the size in the height direction. Setting the value L1H/LL in the conditional expressions described above at a value smaller than or equal to the upper limit allows suppression of an increase in the height of the fixed-focus lens, so that the requirement of the product height can be satisfied.

Conditional expression (3) is an expression used to ensure an appropriate back focal length. Setting the value BF/F in the conditional expressions described above at a value greater than or equal to the lower limit can ensure a length necessary for placement of an inserted object such as a prism. Setting the value BF/F in the conditional expressions described above at a value smaller than or equal to the upper limit can achieve a short lens length and a wide-angle field of view of the fixed-focus lens.

### Additional Remark 2

The fixed-focus lens according to Additional Remark 1, wherein the first lens group is configured with single lenses or cemented lenses having positive, positive, negative, negative, and negative refractive power and arranged from the reduction side.

In the thus configured fixed-focus lens, to spread the beams on the enlargement side of the first lens group, it is essential to arrange negative lenses sequentially from the enlargement side. It is necessary to dispose a positive lens on the reduction side for size reduction. Large positive power is suitable for the size reduction, but is not preferable in terms of aberrations. The present configuration, in which two lenses each having positive refractive power are arranged side by side on the reduction side, allows reduction in the amount of aberrations produced per one positive lens, and the size reduction.

### Additional Remark 3

The fixed-focus lens according to Additional Remark 1 or 2, wherein the second lens group is configured with single lenses or cemented lenses having negative, positive, positive, negative, and positive refractive power and arranged from the enlargement side.

In the configuration described above, since the first lens group has positive refractive power, it is preferable to correct the aberrations by using a negative lens as an enlargement-side lens closest to the first lens group. A lens having large positive refractive power is used near the aperture stop for size reduction, but this configuration in which a single lens produces the large positive power makes it difficult to correct the aberrations. It is therefore preferable to divide and distribute the positive power. It is necessary to dispose a positive lens on the reduction side to secure the telecentricity, and it is necessary to dispose a negative lens to correct the drawback caused by placement of the positive lens.

### Additional Remark 4

The fixed-focus lens according to any one of Additional Remarks 1 to 3, wherein the second lens group includes an aspherical lens having positive refractive power.

Astigmatism can thus be effectively suppressed, and the diameters of the lenses constituting the second lens group and the cost thereof can be reduced as compared with the case where the second lens group is configured only with spherical lenses.

### Additional Remark 5

The fixed-focus lens according to any one of Additional Remarks 1 to 4, wherein the lens closest to the enlargement side in the second lens group is a negative cemented lens configured with a lens having positive refractive power and a lens having negative refractive power.

The fixed-focus lens can thus achieve a wide-angle field of view, size reduction, and suppression of chromatic aberrations.

### Additional Remark 6

The fixed-focus lens according to any one of Additional Remarks 1 to 5, satisfying a conditional expression below,

$$3. < Fg 1 p / F < 25. \qquad ( 4 )$$

where
Fg1p: Focal length of lens closest to reduction side in first lens group.

Conditional expression (4) is an expression used to reduce the size of the fixed-focus lens and correct the aberrations produced by the fixed-focus lens. Setting the value Fg1p/F in the conditional expression described above at a value greater than or equal to the lower limit allows advantageous aberration correction while maintaining the size reduction. Setting the value Fg1p/F in the conditional expression described above at a value smaller than or equal to the upper limit can achieve the size reduction while allowing the advantageous aberration correction.

### Additional Remark 7

The fixed-focus lens according to any one of Additional Remarks 1 to 6, satisfying a conditional expression below,

$$0.2 < Fg 2 p 1 / Fg 2 p 2 < 1.2 \qquad ( 5 )$$

where
Fg2p1: Focal length of positive single lens or positive cemented lens disposed at position closest to enlargement side in second lens group, and
Fg2p2: Focal length of positive single lens or positive cemented lens disposed at position second closest to enlargement side in second lens group.

Conditional expression (5) shows how the power is distributed to the two enlargement-side positive lenses in the second lens group. Satisfying Conditional Expression (5) allows favorable correction of the various aberrations caused by the reduction in size of the fixed-focus lens and the increase in the wide-angle field of view thereof.

### Additional Remark 8

The fixed-focus lens according to any one of Additional Remarks 1 to 7, satisfying a conditional expression below,

$$0.8 < \vert Fg 2 n 1 / Fg 2 p 3 - \vert < 2.8 \qquad ( 6 )$$

where
Fg2n1: Focal length of negative single lens or negative cemented lens disposed at position closest to reduction side in second lens group, and
Fg2p3−: Focal length of positive lens disposed at position closer to reduction side than negative single lens or negative cemented lens disposed at position closest to reduction side in second lens group.

Conditional expression (6) is an expression used to ensure the telecentricity and correct the chromatic aberration of magnification. Setting the value Fg2n1/Fg2p3− of the conditional expression described above at a value greater than or equal to the lower limit can ensure the telecentricity. Setting the value Fg2n1/Fg2p3− of the conditional expression described above at a value smaller than or equal to the upper limit allows favorable correction of the chromatic aberration of magnification.

### Additional Remark 9

The fixed-focus lens according to any one of Additional Remarks 1 to 8, satisfying a conditional expression below,

$$0.45 < LS / LL < 0.65 \qquad ( 7 )$$

where
LS: Distance from lens surface of fixed-focus lens that is closest to enlargement side to aperture stop.

Conditional Expression (7) is an expression relating to reducing the diameters of the lenses and ensuring the telecentricity. Setting the value LS/LL of the conditional expression described above at a value greater than or equal to the lower limit can ensure the telecentricity. Setting the value LS/LL in the conditional expression described above at a value smaller than or equal to the upper limit allows reduction in the diameters of the lenses.

### Additional Remark 10

A projector including:

an image forming section including a light modulator configured to modulate light from a light source apparatus to form image light; and
the fixed-focus lens according to any one of Additional Remarks 1 to 9, which projects the image light from the image forming section.

The size of the projector including the fixed-focus lens can thus be reduced.

What is claimed is:

1. A fixed-focus lens comprising: a first lens group; an aperture stop; and a second lens group sequentially arranged from an enlargement side toward a reduction side, the first and second lens groups each having positive refractive power, wherein
a lens closest to the enlargement side or a lens second closest to the enlargement side in the first lens group is an aspherical lens,
the reduction side of the fixed-focus lens is a telecentric system, and
the fixed-focus lens satisfies conditional expressions below,
$$ω > 45 \qquad ( 1 )$$
$$0.15 < L 1 H / LL < 0. 4 \qquad ( 2 )$$
$$2.5 < BF / F < 3.5 \qquad ( 3 )$$
where
ω: Largest half viewing angle of fixed-focus lens,
L1H: Height of beam passing through top of maximum image height at lens surface of fixed-focus lens that is closest to enlargement side,
LL: Length of fixed-focus lens
BF: Back focal length in air, and
F: Focal length of entire fixed-focus lens.

2. The fixed-focus lens according to claim 1, wherein
the first lens group is configured with single lenses or cemented lenses having positive, positive, negative, negative, and negative refractive power and arranged from the reduction side.

3. The fixed-focus lens according to claim 1, wherein
the second lens group is configured with single lenses or cemented lenses having negative, positive, positive, negative, and positive refractive power and arranged from the enlargement side.

4. The fixed-focus lens according to claim 1, wherein
the second lens group includes an aspherical lens having positive refractive power.

5. The fixed-focus lens according to claim 1, wherein
the lens closest to the enlargement side in the second lens group is a negative cemented lens configured with a lens having positive refractive power and a lens having negative refractive power.

6. The fixed-focus lens according to claim 1, satisfying a conditional expression below,
$$3. < Fg 1 p / F < 25. \qquad ( 4 )$$
where
Fg1p: Focal length of lens closest to reduction side in first lens group.

7. The fixed-focus lens according to claim 1, satisfying a conditional expression below,
$$0.2 < Fg 2 p 1 / Fg 2 p 2 < 1.2 \qquad ( 5 )$$
where
Fg2p1: Focal length of positive single lens or positive cemented lens disposed at position closest to enlargement side in second lens group, and
Fg2p2: Focal length of positive single lens or positive cemented lens disposed at position second closest to enlargement side in second lens group.

8. The fixed-focus lens according to claim 1, satisfying a conditional expression below,
$$0.8 < \vert Fg 2 n 1 / Fg 2 p 3 - \vert < 2.8 \qquad ( 6 )$$
where
Fg2n1: Focal length of negative single lens or negative cemented lens disposed at position closest to reduction side in second lens group, and
Fg2p3−: Focal length of positive lens disposed at position closer to reduction side than negative single lens or negative cemented lens disposed at position closest to reduction side in second lens group.

9. The fixed-focus lens according to claim 1, satisfying a conditional expression below,
$$0.45 < LS / LL < 0.65 \qquad ( 7 )$$
where
LS: Distance from lens surface of fixed-focus lens that is closest to enlargement side to aperture stop.

10. A projector comprising:
an image forming section including a light modulator configured to modulate light from a light source apparatus to form image light; and
the fixed-focus lens according to claim 1, which projects the image light from the image forming section.
